(19) United States
(12) Patent Application Publication
(10) Pub. No.: US 2007/0204102 A1
(43) Pub. Date: Aug. 30, 2007

(54) Cache feature in electronic devices

(75) Inventors: Thomas Luby, Tokyo (JP); Vladimir Ermolov, Espoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/365,792

(22) Filed: Feb. 28, 2006

(51) Int. Cl. G06F 13/00

(52) U.S. Cl. 711/113

(57) ABSTRACT

The specification and drawings present a new method, system, apparatus and software product for increasing operation time in electronic devices (e.g., mobile electronic devices) by using a cache for a hard disk. By adding a read/write memory, e.g. a flash memory, to buffer the accesses from the hard disk, it is possible to cache extra data in an anticipation that the next requested data to be read (e.g., requested by an application processor) will be present in the additional read/write memory. This eliminates the need to keep the hard disk spinning for long periods of time and thus significantly reduces the hard disk spinning time and power consumption.

### FIELD OF THE INVENTION

This invention generally relates to mobile electronic devices and more specifically to increasing operation time of the electronic devices by using a cache feature.

### BACKGROUND ART

Data, multimedia services and new applications require more and more memory to be present in mobile terminals (electronic devices). Great progress has been made to integrate traditional mass memory technology such as hard disks, portable optical disks and also new MEMS (micro-electro-mechanical system) storage into portable devices. These technologies provide large amounts of memory storage, but they require significant operational power, which limits the operation time and/or storage volume of such devices.

### DISCLOSURE OF THE INVENTION

According to a first aspect of the invention, a method for using a cache feature in a mobile electronic device, comprises the steps of: determining by a cache control module, using a predetermined criterion, at least one file to be loaded to a read/write memory in anticipation that said at least one file is to be requested by a request signal sent to said cache control module; and loading said at least one file to said read/write memory.

According further to the first aspect of the invention, the at least one file may be loaded from at least one further memory area. Further, before the loading step, the method may comprise the step of: providing to the read/write memory a loading instruction of the at least one file. Further still, at least one further memory may be a hard disk, an optical disk or a micro-electro-mechanical system (MEMS) storage.

Further according to the first aspect of the invention, at least one further memory may be an internal part of the mobile communication device.

Still further according to the first aspect of the invention, the at least one further memory may be an external part of the mobile communication device.

According further to the first aspect of the invention, the at least one file may be created by the mobile electronic device and loaded to the read/write memory first. Further, the first aspect may further comprise the steps of: determining a time when the at least one file to be written from the read/write memory to at least one further memory area according to a pre-selected algorithm; and writing the at least one file to the at least one further memory area for storing.

According still further to the first aspect of the invention, the request signal may be provided by an application processor of the mobile electronic device.

According further still to the first aspect of the invention, the read/write memory may be a flash memory. Further, the flash memory may be multimedia cards or a secure digital flash memory.

According yet further still to the first aspect of the invention, the at least one file may be determined by a cache determining block of the cache control module.

Yet still further according to the first aspect of the invention, the read/write memory and the cache control module may be imbedded in one integrated circuit.

Still yet further according to the first aspect of the invention, the read/write memory may be operated using wear leveling.

Still further still according to the first aspect of the invention, the read/write memory may be a random access memory.

According further still to the first aspect of the invention, the read/write memory may be an external card. Further, the external card may comprise: a buffer read/write memory, for storing the at least one file; and a user data storage area, wherein a size of the buffer and the user data storage area can be dynamically changed using a pre-selected procedure.

According to a second aspect of the invention, a computer program product comprises: a computer readable storage structure embodying computer program code thereon for execution by a computer processor with the computer program code characterized in that it includes instructions for performing the steps of the first aspect of the invention, indicated as being performed by any component or a combination of components of the mobile electronic device.

According to a third aspect of the invention, a mobile electronic device with cache features, comprises: a read/write memory, responsive to a cache control signal, for loading at least one file to the read/write memory; and a cache control module, for determining, using a predetermined criterion, at least one file to be loaded to the read/write memory in anticipation that the at least one file is to be requested by a request signal sent to the cache control module, and for providing the cache control signal comprising a loading instruction of the at least one file.

According further to the third aspect of the invention, the mobile electronic device may further comprise: an application processor, for providing the request signal.

Further according to the third aspect of the invention, the mobile electronic device may further comprise: at least one further memory area, wherein the at least one file may be loaded from at least one further memory area. Further, the at least one further memory may be a hard disk, an optical disk or a micro-electro-mechanical system (MEMS) storage.

Still further according to the third aspect of the invention, the at least one file may be created by the mobile communication electronic device and loaded to the read/write memory first. Further, the cache control module may determine a time when the at least one file to be written from the read/write memory to at least one further memory area according to a pre-selected algorithm.

According further to the third aspect of the invention, the read/write memory may be a flash memory. Further, the flash memory may be multimedia cards or a secure digital flash memory.

According still further to the third aspect of the invention, the cache control module may comprise: a cache determining block, for determining the at least one file.

According yet further still to the third aspect of the invention, the read/write memory and the cache control module may be imbedded in one integrated circuit.

According further still to the third aspect of the invention, the read/write memory may be operated using wear leveling.

Yet still further according to the third aspect of the invention, the read/write memory may be a random access memory.

Still yet further according to the third aspect of the invention, the read/write memory may be an external card. Further, the external card may comprise: a buffer read/write memory, for storing the at least one file, and a user data storage area, for storing user data, wherein a size of the buffer and the user data storage area can be dynamically changed using a pre-selected procedure.

Still further still according to the third aspect of the invention, the mobile electronic device may be a communication device, a portable computer, a wireless communication device, a portable electronic device, a mobile electronic device or a mobile phone.

According to a fourth aspect of the invention, an integrated circuit, comprises: a read/write memory, responsive to a cache control signal, for loading at least one file to the read/write memory; and a cache control module, for determining, using a predetermined criterion, at least one file to be loaded to the read/write memory in anticipation that the at least one file is to be requested by a request signal sent to the cache control module, and for providing the cache control signal comprising a loading instruction of the at least one file.

### BRIEF DESCRIPTION OF THE DRAWINGS

For a better understanding of the nature and objects of the present invention, reference is made to the following detailed description taken in conjunction with the following drawings, in which:

FIG. 1 is a general block diagram of an electronic device for increasing operation time by using a cache for a hard disk, according to an embodiment of the present invention;

FIG. 2 is a block diagram of an electronic device for increasing operation time by using a cache for a hard disk and using a cache determining block (e.g., a predictor or a processor), according to further embodiments of the present invention; and

FIG. 3 is a block diagram of an electronic device for increasing operation time by using a cache for a hard disk and using a dual purpose external card, according to an embodiment of the present invention.

### MODES FOR CARRYING OUT THE INVENTION

A new method, apparatus and software product are presented for increasing operation time in electronic devices (e.g., mobile devices) by using a cache feature. In order to increase the operation time of the mobile devices with high power memories such as hard disks, optical disks, a micro-electro-mechanical system (MEMS) storage, etc. and limited batteries, embodiments of the present invention describe a way to reduce the power consumption, e.g., by reducing the length of time that, e.g., the hard disk (or an optical disk) is spinning (and particularly to reduce the number of power intensive spin-up cycles). By adding a read/write memory (e.g. a flash memory, an external card flash memory, a random access memory, or any other type of a low-power memory) to buffer the accesses from the high power memory, it is possible to cache extra data in an anticipation that the next requested data (e.g., requested by an application processor) will be present in the additional read/write memory. This eliminates the need to keep, e.g., the hard disk (or the optical disk) spinning for long periods of time (e.g., reducing the spin-up time in the case when the hard disk has entered a power save mode and stopped spinning), or generally reducing the power consumption during the read operation thus significantly reducing the power consumption in the electronic devices.

Moreover, according to a further embodiment of the present invention, files created by the electronic device can be first loaded to the read/write memory before they are loaded to the high power memory (e.g., for more permanent storage) such that these files can be accessed (e.g., requested by the application processor) by the electronic device directly from the read/write memory. These files, however can be loaded (written) to the high power memory for more permanent storage (mass storage such as hard disks, optical disks, MEMS storage, etc.) using a pre-selected algorithm, e.g., when there is not enough memory space the read/write memory or reaching a certain percentage full in the read/write memory. This decision can be made, e.g., by a cache controller.

According to an embodiment of the present invention, the flash memory can be multimedia cards (MMC), a secure digital (SD) flash memory, MEMS (micro-electro-mechanical system) flash memory or other flash based memory cards. The mobile electronic device can be (but is not limited to): a communication device, a wireless communication device, a portable electronic device, a portable computer (e.g., a laptop computer), a mobile electronic device, MP3 player, personal digital assistant (PDA) device a mobile phone, etc. It is noted that the various embodiments of the present invention can be also applied to non-portable devices.

For example, to further minimize the hard disk spin-up time, according to an embodiment of the present invention, the cache controller (or a cache control block) can be programmed by the application processor to determine according to a predetermined criterion what the future file accesses will be. Therefore, the next time the hard disk is spun-up to read data, the read/write (e.g., flash) memory can be filled intelligently with the data that will be possibly required in the future to be read directly from the read/write memory which will save power resources and increase the device operation time.

Typical applications such as music playback will benefit tremendously from using embodiments of the present invention. In current music players, the hard disk is typically accessed once or twice per song. In a music player application, the user typically selects to play songs randomly, by genre, by album, etc. Once selected, the chosen play-list can be programmed into the cache controller in order to intelligently pre-fetch the data from the hard disk. For example, with a 256 Mbit read/write memory, it may be only needed to access the hard disk every 10 songs (30 minutes approx.), dramatically increasing the playback time possible from a limited capacity battery.

In case of using flash memory for the read/write memory, it has a limited number of read-erase cycles (typically about 100,000). According to an embodiment of the present invention, a journaling file system (e.g. Journaling Flash File System, JFFS) can be used to enable wear leveling (i.e., each storage element in the memory will be used an equal number of times) and therefore increase reliability of the memory.

Additionally, since the data will be read from the memory rather than directly from, e.g., the hard disk, the data rate will be increased (especially if it is required to wait approximately 1 second for the hard disk to spin-up). Moreover, most of the time the hard disk will be in an idle mode and this consequently will improve the reliability and shock resistance of the mobile device. Furthermore, if removable external flash memory cards are used, they can be replaced should they fail and/or they can be upgraded in terms of size to increase performance based on user requirements.

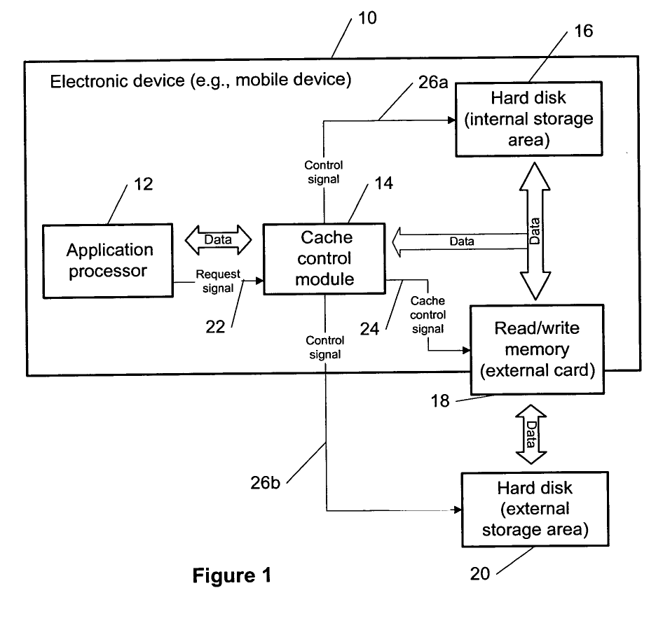

FIG. 1 shows one example among others of a general block diagram of an electronic device 10 (e.g. a mobile device) for increasing operation time by using the cache feature, according to an embodiment of the present invention.

An application processor 12 can provide a request signal 22 comprising a request for a desired file to a cache control module 14 of the mobile electronic device 10. The desired file can be stored, e.g., in a hard disk 16 (internal) or 20 (external) from which the desired file can be temporarily loaded to the read/write memory 18 (e.g., an external card). The cache control module 14 determines (not necessarily using the request signal 22), using the predetermined criterion, an instruction for loading at least one file (or multiple files) from at least one hard disk 16 or 20 to the read/write memory 18 in anticipation that the at least one file is to be requested by said request signal.

After the above determination, the cache control module 14 provides this instruction (a cache control signal 24) to the read/write memory 18 to facilitate the loading of the at least one file (or the multiple files). Also, control signals 26a and/or 26b can be provided by the block 14 to the hard disk blocks 16 and/or 20, respectively, for facilitating this loading of the at least one file (or the multiple files) from the hard disks 26 and/or 20 to the read/write memory 18. According to an embodiment of the present invention, the read/write memory 18 can be implemented as an external card which can be embedded in one integrated circuit with the cache control module 14 in the device 10.

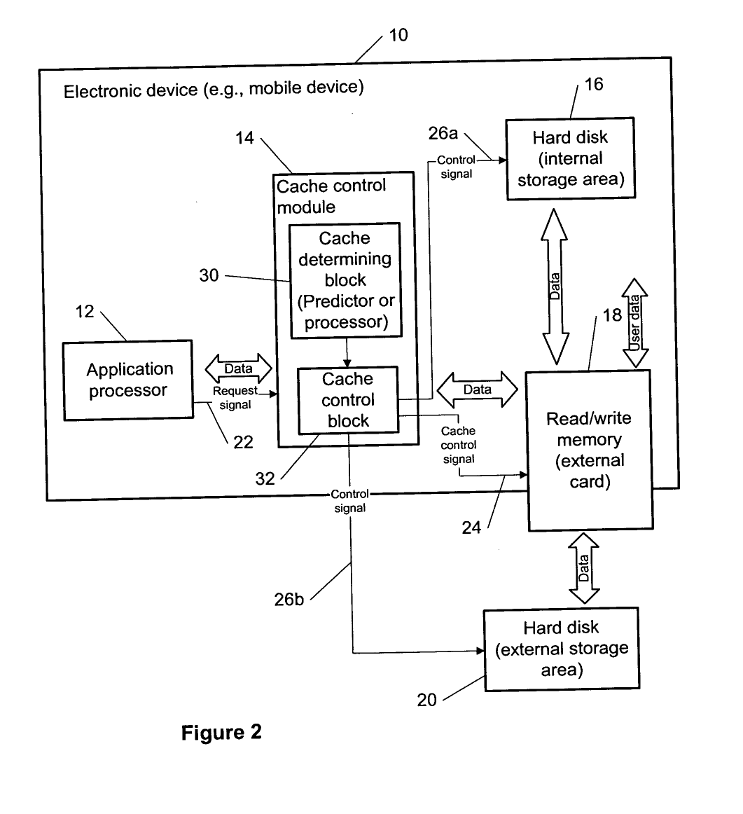

FIG. 2 shows another example among others of a block diagram of an electronic device 10 (e.g., the mobile device) for increasing operation time by using the cache feature and using cache determining block 30 as a unique block within the cache control module 14, according to further embodiments of the present invention. The function of the block 30 is to determine using the predetermined criterion at least one file (or multiple files) to be loaded from at least one hard disk 16 or 20 to the read/write memory 18 in anticipation that the at least one file is to be requested by the application processor 12, as described above. After the determination, the cache control block 32 generates the corresponding instruction and provides signals 24, 26a and 26b, as discussed above.

According to one embodiment of the present invention, the block 30 can be a predictor block utilizing additional logic. To increase the performance and decrease power consumption, the predictor block 30 within the cache control module 14 learns about the most popular files, for example, by monitoring what files are being read from the hard disks 16 and/or 20 and not necessarily using information provided in the request signal 22 by the application processor. This way, the read/write memory 18 can be loaded with these files, which will increase the chances of a successful “cache hit”. One way to use this data successfully is to always load a certain percentage of the buffer (i.e., of the block 18) with identified files. Another possibility is to pre-load the buffer with these files when the user switches on the mobile device 10.

Moreover, according to a further embodiment of the present invention, files created by the electronic device 10 can be first loaded to the read/write memory 18 (e.g., written in the memory 18 by the application processor 12) before they are saved in the hard disk 16 or 20 such that these files can be requested, e.g., by the application processor 12 directly from the read/write memory 18 using the cache feature, thus saving power (i.e., no need for spinning) and/or time (faster access). These files, however, can be loaded (written) to the hard disk 16 or 20 for more permanent storage using a pre-selected algorithm, e.g., when there is not enough memory space in the read/write memory 18 or when reaching a certain percentage full in the read/write memory 18. The decision for loading these files to the hard disk 16 or 20 can be made, e.g., by the cache control module 14.

Furthermore, all memories can suffer from de-fragmentation, which means that a particular file can be split across different addresses. This is true of hard disks as well. In the case of a de-fragmented drive being used, the cache control module 14 would simply fill space in the block 18 with non-relevant data if the accessed file was split which may or may not be a continuation of the accessed file. As the hard disk becomes more fragmented, the chances of the whole file being cached this way becomes less and less likely. To further aid the quest for minimizing the hard disk spin-up time, according to another embodiment of the present invention, the cache determining block 30 can be an embedded processor that is aware of the filesystem used on the mass storage (e.g., the hard disk 16). Then, an incoming file access will be understood by the embedded processor 30 and the processor 30 will be able to directly control the cache in order to retrieve all parts of the file and store it into the memory block 18.

It is noted that the cache determining block 30 can auto-defrag the hard disk when the system has been idle for a pre-determined length of time. Unlike normal hard disk de-fragmentation programs that start writing data “from the inside out”, the de-fragmentation, according to an embodiment of the present invention, can work “outside to in”. The reason for this is because the outside of the hard disks spins faster and therefore the data can be read quicker. Also, the benefit of writing data to the “outside” of the hard disks is that the power used is less, i.e., the motor needs to spin slower to achieve the same data rate and the track is longer meaning less moving the head to another track.

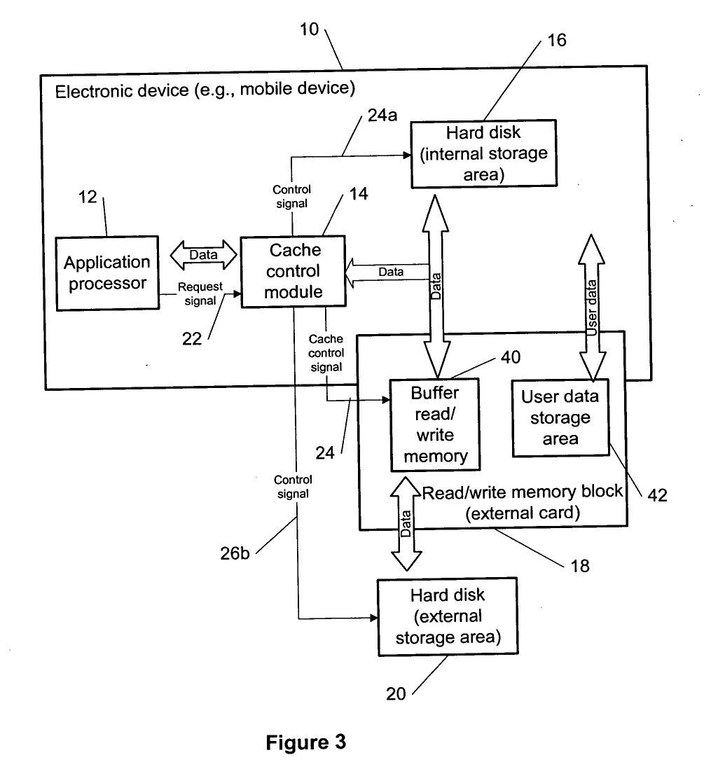

FIG. 3 is another example among others of a block diagram of the mobile electronic device 10 for increasing operation time by using a cache for a hard disk and using a dual purpose external card 18a, according to an embodiment of the present invention;

In this embodiment it is disclosed that the entire external card 18a does not need to be used as a buffer. A user application on the host processor can dynamically partition the card for buffering performed by a buffer read/write memory 40 as described by various embodiments of the present invention and for storing user data by a user data storage area 42. Furthermore, according to another embodiment, the buffer block 40 can grow or shrink automatically depending on the memory space it requires using a pre-selected procedure. Alternatively, the block 40 can simply use whatever free space is available, or the user can specify exactly what space (or the maximum space) to use.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. A method, comprising:
determining by a cache control module of a mobile electronic device, using a predetermined criterion, at least one file to be loaded to a read/write memory in anticipation that said at least one file is to be requested by a request signal sent to said cache control module; and
loading said at least one file to said read/write memory.

2. The method of claim 1, wherein said at least one file is loaded from at least one further memory area.

3. The method of claim 2, wherein before said loading step, the method comprises:
providing to the read/write memory a loading instruction of said at least one file.

4. The method of claim 2, wherein said at least one further memory is a hard disk, an optical disk or a micro-electro-mechanical system storage.

5. The method of claim 1, wherein said at least one further memory is an internal part of the mobile communication device.

6. The method of claim 1, wherein said at least one further memory is an external part of the mobile communication device.

7. The method of claim 1, wherein said at least one file is created by said mobile electronic device and loaded to said read/write memory first.

8. The method of claim 1, wherein said method further comprises:
determining a time when said at least one file to be written from said read/write memory to at least one further memory area according to a pre-selected algorithm; and
writing said at least one file to the at least one further memory area for storing.

9. The method of claim 1, wherein the request signal is provided by an application processor of said mobile electronic device.

10. The method of claim 1, wherein said read/write memory is a flash memory.

11. The method of claim 10, wherein said flash memory is multimedia cards or a secure digital flash memory.

12. The method of claim 1, wherein said at least one file is determined by a cache determining block of the cache control module.

13. The method of claim 1, wherein said read/write memory and said cache control module are imbedded in one integrated circuit.

14. The method of claim 1, wherein said read/write memory is operated using wear leveling.

15. The method of claim 1, wherein said read/write memory is a random access memory.

16. The method of claim 1, wherein said read/write memory is an external card.

17. The method of claim 11, wherein said mobile electronic device is a communication device, a portable computer, a wireless communication device, a portable electronic device, a mobile electronic device or a mobile phone.

18. A computer program product comprising:
a computer readable storage structure embodying computer program code thereon for execution by a computer processor with said computer program code, wherein said computer program code comprises instructions for performing the method of claim 1, indicated as being performed by any component or a combination of components of the mobile electronic device.

19. A mobile electronic device, comprising:
a read/write memory, responsive to a cache control signal, configured to load at least one file to the read/write memory; and
a cache control module, configured to determine, using a predetermined criterion, at least one file to be loaded to the read/write memory in anticipation that said at least one file is to be requested by a request signal sent to said cache control module, and to provide the cache control signal comprising a loading instruction of said at least one file.

20. The mobile electronic device of claim 19, further comprising:
an application processor, for providing said request signal.

21. The mobile electronic device of claim 19, further comprising:
at least one further memory area, wherein said at least one file is loaded from at least one further memory area.

22. The mobile electronic device of claim 21, wherein said at least one further memory is a hard disk, an optical disk or a micro-electro-mechanical system storage.

23. The mobile electronic device of claim 19, wherein said mobile communication electronic device is configured to create said at least one file and to load said at least one file to said read/write memory first.

24. The mobile electronic device of claim 23, wherein said cache control module is configured to determine a time when said at least one file to be written from said read/write memory to at least one further memory area according to a pre-selected algorithm.

25. The mobile electronic device of claim 19, wherein said read/write memory is a flash memory.

26. The mobile electronic device of claim 25, wherein said flash memory is multimedia cards or a secure digital flash memory.

27. The mobile electronic device of claim 19, wherein said cache control module comprises: a cache determining block, configured to determine said at least one file.

28. The mobile electronic device of claim 19, wherein said read/write memory and said cache control module are imbedded in one integrated circuit.

29. The mobile electronic device of claim 19, wherein said read/write memory is configured to operate using wear leveling.

30. The mobile electronic device of claim 19, wherein said read/write memory is a random access memory.

31. The mobile electronic device of claim 14, wherein said read/write memory is an external card.

32. The mobile electronic device of claim 31, wherein said external card comprises:
a buffer read/write memory, configured to store said at least one file, and
a user data storage area, configured to store user data,
wherein said buffer and said user data storage area are configured for being dynamically changed in size using a pre-selected procedure.

33. (canceled)

34. An integrated circuit, comprising:
a read/write memory, responsive to a cache control signal, configured to load at least one file to the read/write memory; and
a cache control module, configured to determine, using a predetermined criterion, at least one file to be loaded to the read/write memory in anticipation that said at least one file is to be requested by a request signal sent to said cache control module, and to provide the cache control signal comprising a loading instruction of said at least one file.

35. The integrated circuit of claim 34, wherein said read/write memory is a flash memory.

36. A mobile electronic device, comprising:
means for controlling, responsive to a cache control signal, for loading at least one file to the read/write memory; and
means for determining, using a predetermined criterion, at least one file to be loaded to the read/write memory in anticipation that said at least one file is to be requested by a request signal sent to said cache control module, and for providing the cache control signal comprising a loading instruction of said at least one file.

37. The mobile electronic device of claim 36, wherein means for controlling is a read/write memory and means for determining is a cache control module.
